(19) United States
(12) Patent Application Publication
(10) Pub. No.: US 2025/0386166 A1
(43) Pub. Date: Dec. 18, 2025

(54) PUBLIC LAND MOBILE NETWORK SEARCH OPTIMIZATION

(71) Applicant: QUALCOMM Incorporated, San Diego, CA (US)

(72) Inventors: Alexandros MANOLAKOS, Athens (GR); Mukesh KUMAR, Hyderabad (IN); Guttorm Ringstad OPSHAUG, Redwood City, CA (US)

(21) Appl. No.: 18/879,187

(22) PCT Filed: Jul. 25, 2023
(86) PCT No.: PCT/US2023/028559

§ 371 Date: Dec. 26, 2024

(30) Foreign Application Priority Data
Aug. 16, 2022 (GR) 20220100688

(51) Int. Cl. H04W 4/02; H04B 17/318; H04W 84/04

(52) U.S. Cl. CPC H04W 4/025; H04B 17/328; H04W 84/042

(57) ABSTRACT

A user equipment (UE) may be configured to obtain an indication of a set of public land mobile networks (PLMNs). The UE may be configured to receive positioning reference signal (PRS) assistance data from a network entity. The PRS assistance data may be associated with a set of PRSs for the set of PLMNs. The UE may be configured to select a subset of PLMNs in the set of PLMNs based on the PRS assistance data or at least one measurement for the set of PRSs. The UE may be configured to initiate a search for the subset of PLMNs based on the PRS assistance data or the at least one measurement for the set of PRSs.

### CROSS-REFERENCE TO RELATED APPLICATION

This application claims the benefit of Greece patent application Ser. No. 20220100688, entitled “PUBLIC LAND MOBILE NETWORK SEARCH OPTIMIZATION” and filed on Aug. 16, 2022, which is expressly incorporated by reference herein in its entirety.

### TECHNICAL FIELD

The present disclosure relates generally to communication systems, and more particularly, to a system for registering with a public land mobile networks (PLMN).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may be configured to obtain an indication of a set of public land mobile networks (PLMNs). The apparatus may be configured to receive positioning reference signal (PRS) assistance data from a network entity. The PRS assistance data may be associated with a set of PRSs for the set of PLMNs. The apparatus may be configured to select a subset of PLMNs in the set of PLMNs based on the PRS assistance data or at least one measurement for the set of PRSs. The apparatus may be configured to initiate a search for the subset of PLMNs based on the PRS assistance data or the at least one measurement for the set of PRSs.

In an aspect of the disclosure, a method, a computer-readable medium, and an apparatus at a network entity are provided. The apparatus may be configured to receive a request for a set of PLMNs from a UE. The apparatus may be configured to transmit an indication of the set of PLMNs to the UE. The apparatus may be configured to transmit PRS assistance data to the UE. The PRS assistance data may be associated with a set of PRSs for the set of PLMNs.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating a layered system of searching PLMN resources for cell selection.

FIG. 6 is a diagram illustrating a structure for a cell global identifier message.

FIG. 7 is a diagram illustrating another layered system of searching PLMN resources for cell selection.

FIG. 8 is a connection flow diagram illustrating communication between a network entity and a UE that searches PLMN resources for cell selection.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

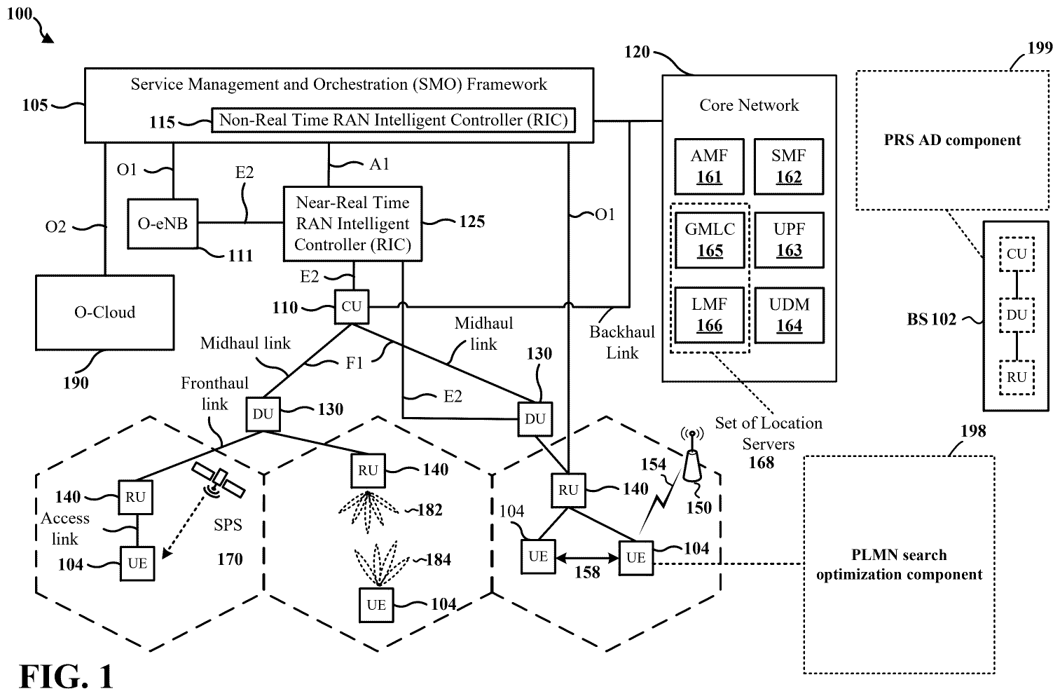

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a PLMN search optimization component 198 configured to obtain an indication of a set of PLMNs. The PLMN search optimization component 198 may be configured to receive PRS assistance data from a network entity. The PRS assistance data may be associated with a set of PRSs for the set of PLMNs. The PLMN search optimization component 198 may be configured to select a subset of PLMNs in the set of PLMNs based on the PRS assistance data or at least one measurement for the set of PRSs. The PLMN search optimization component 198 may be configured to initiate a search for the subset of PLMNs based on the PRS assistance data or the at least one measurement for the set of PRSs. In certain aspects, the base station 102 may have a PRS assistance data component 199 configured to receive a request for a set of PLMNs from a UE. The PRS assistance data component 199 may be configured to transmit an indication of the set of PLMNs to the UE. The PRS assistance data component 199 may be configured to transmit PRS assistance data to the UE. The PRS assistance data may be associated with a set of PRSs for the set of PLMNs. Although the following description may be focused on 5G NR, the concepts described herein may be applicable to other similar areas, such as LTE, LTE-A, CDMA, GSM, and other wireless technologies.

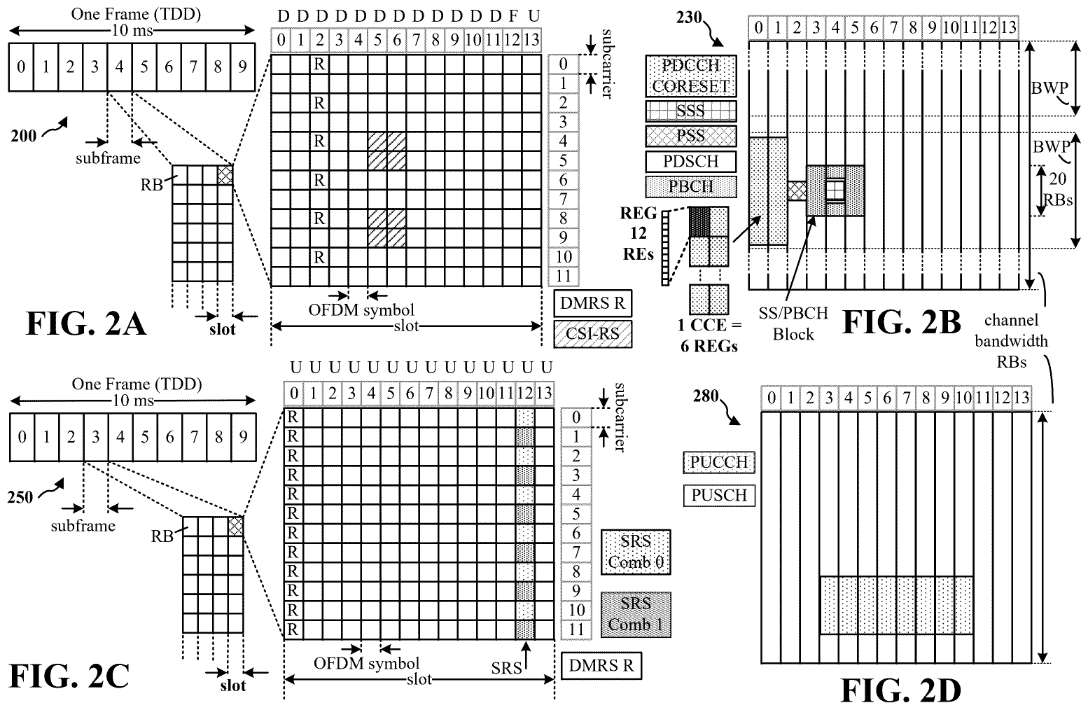

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

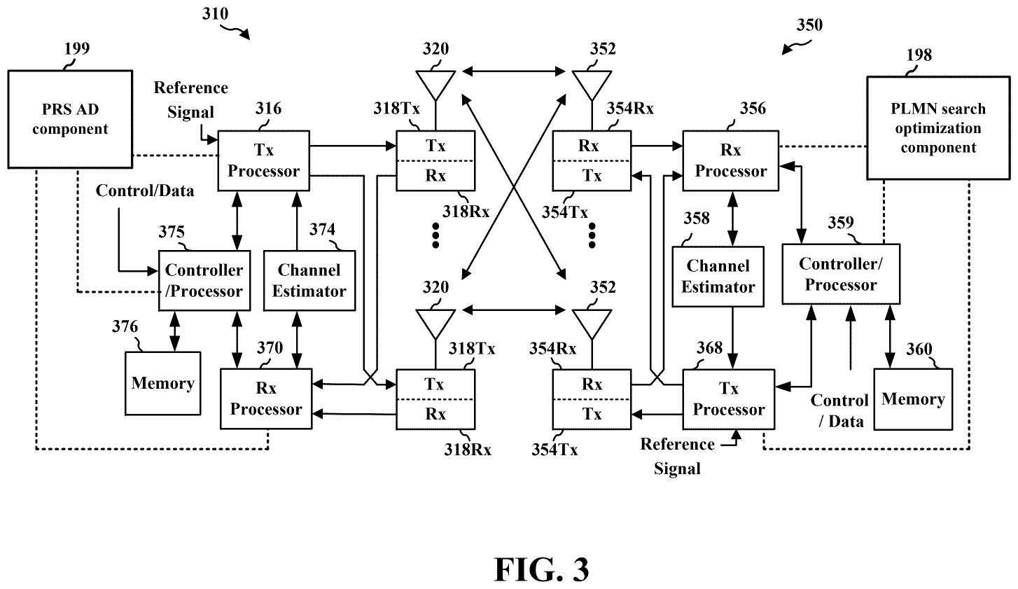

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the PLMN search optimization component 198 of FIG. 1.

At least one of the Tx processor 316, the Rx processor 370, and the controller/processor 375 may be configured to perform aspects in connection with the PRS assistance data component 199 of FIG. 1.

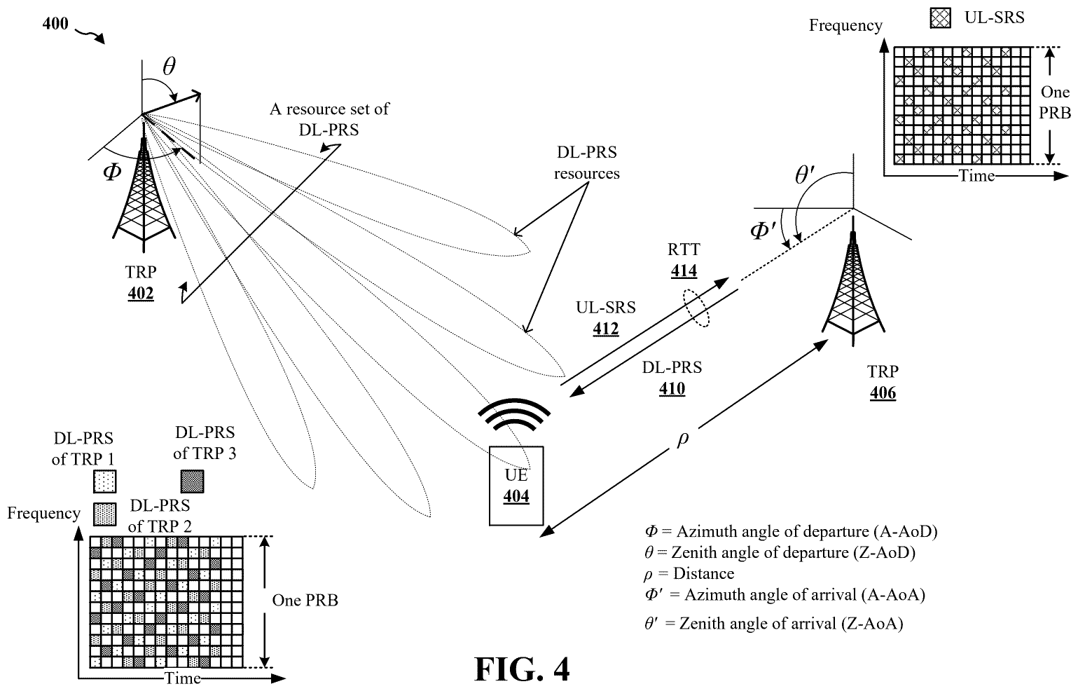

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

A PLMN may include a combination of wireless communication services, such as a cellular network, offered by an operator in a region to provide wireless communication services to a UE. The UE may be configured to search PLMN resources in response to a bootup sequence, or in response to losing a connection with a serving cell for a threshold period of time. The UE may be configured to search for all PLMN resources in each band (e.g., FR1, FR2, etc.) and each technology (e.g., NR, LTE, etc.) to determine what PLMN resources may be available for connection or registration. A UE may be configured to perform manual PLMN selection or automatic PLMN selection. For manual PLMN selection, the UE may be configured to provide a list of available PLMN to an output user interface of the UE, such as a display or a speaker. The UE may then obtain a selection of a PLMN from an input user interface of the UE, such as a touch screen display or a keyboard, to select a PLMN for connection or registration.

For automatic PLMN selection, a UE may be configured to search public land mobile network (PLMN) resources to determine an optimal PLMN before selecting a PLMN for connection or registration. For example, a UE may be configured to search PLMN resources to identify a PLMN with better coverage than other PLMNs, and/or to identify a PLMN with a better data communication rate than other PLMNS. In some aspects, a UE may be configured to automatically select a PLMN that has better 4G or 5G cell coverage. A UE may be configured to select a cell with a home PLMN (HPLMN) or an equivalent HPLMN (EHPLMN). The UE may be configured to automatically register with a PLMN that it has selected. In response to the UE losing coverage for HPLMN or EHPLMN, the UE may be configured to connect to a cell with a visitor PLMN (VPLMN). The UE may select a PLMN based on the cell power and the PLMN configuration.

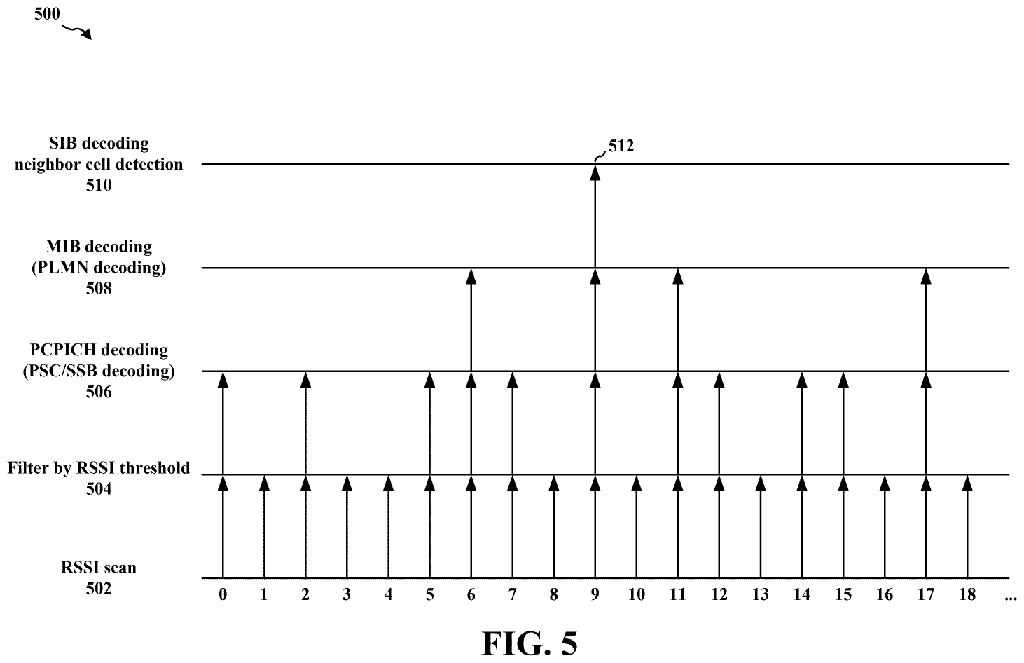

FIG. 5 shows a diagram 500 of a layered system that a UE, such as the UE 104 in FIG. 1, may use to search PLMN resources for cell selection. At 502, the UE may scan a set of channels to measure a received signal strength indicator (RSSI) of each channel of the set of channels. In one aspect, the UE may tune to each and every channel that it supports and measure an RSSI of each channel that the UE supports. In other words, the UE search space may be directly proportional to the number of frequency bands supported by the UE. The RSSI may be a measurement of energy and/or power the UE may measure for a channel. In the diagram 500, the UE may scan channels 0 to 18 to and measure the received RSSI for each channel to determine which channels have a strong RSSI. In other aspects, a UE may be configured to scan more or less channels. The UE may not know anything about available networks prior to scanning channels to measure RSSI of each channel. The UE may measure the power or energy of each channel and may generate a list of each channel identifier (e.g., 0 to 18) along with a measured RSSI associated with each channel identifier. At 502, the UE may not decode the primary common pilot channel (PCPICH) in wideband code division multiple access (WCDMA) or decode sync/reference signal in LTE or NR to detect a PCI.

At 504, the UE may filter the channels by the measured RSSI by comparing the measured RSSI against an RSSI threshold value. The UE may continue to consider channels having a measured RSSI that is greater or equal to the RSSI threshold value, and may not continue to consider channels having a measured RSSI that is less than or equal to the RSSI threshold value. The RSSI threshold value may be defined by a UE implementation or a chipset implementation. In some aspects, the RSSI threshold value may be provided in a UE capability. The UE may generate a list of each channel identifier having a measured RSSI that is greater or equal to an RSSI threshold value. In diagram 500, the UE may continue to consider channels 0, 2, 5, 6, 7, 9, 11, 12, 14, 15, and 17 in response to determining that the measured RSSI of each of the channels is greater or equal to an RSSI threshold value. In diagram 500, the UE may not continue to consider channels 1, 3, 4, 8, 10, 13, 16, and 18 in response to determining that the measured RSSI of each of the channels is less than or equal to the RSSI threshold value.

At 506, the UE may scan the remaining channels to decode PCPICH at each of the remaining channels. The PCPICH may include a synchronization signal block (SSB) that includes a PCI for the channel. The SSB may be packed with a physical broadcast channel (PBCH). The UE may determine a PCI for each of the remaining channels in response to decoding the PCPICH at each of the remaining channels. The PCPICH may have a packet scheduling (PSC) in WCDMA instead of a PCI. In some aspects, decoding the PCPICH at a channel may not succeed in providing a PCI/PSC. In some aspects, the UE may measure a power of the PCPICH signal. The UE may generate a list of each channel identifier having an associated PCI/PSC that has been successfully decoded from the PCPICH. The UE may not continue to consider channels that were unable to be successfully decoded to obtain a PCI/PSC. In diagram 500, the UE may continue to consider channels 6, 9, 11, and 17 in response to successfully decoding the PCPICH, or the SSB channel, to determine a PCI/PSC associated with the channel. In diagram 500, the UE may not continue to consider channels 0, 2, 5, 7, 12, 14, and 15 in response to failing to decode the PCPICH, or the SSB channel, to determine a PCI/PSC associated with the channel.

At 508, the UE may decode a master information block (MIB) of each remaining channel candidate. The decoded MIB of a channel may include at least one of a frequency, a PCI/PSC, or a PLMN associated with the channel. If the channel candidate does not have a MIB to decode, the UE may fail decoding the MIB. The UE may generate a list of channels having successfully decoded MIBs. The list may have at least one of a frequency, a PCI/PSC, or a PLMN associated with each channel having a successfully decoded MIB. In diagram 500, the UE may continue to consider channel 9 in response to successfully decoding an MIB at channel 9, and may not continue to consider channels 6, 11, and 17 in response to failing to decode an MIB at each of the channels 6, 11, and 17.

At 510, the UE may decode the system information block (SIB) of the PLMN 512 to determine information for registering with the PLMN. While the diagram 500 shows a UE decoding one SIB of the PLMN 512, in some aspects a UE may decode a plurality of SIBs, each corresponding with a PLMN with which the UE may register. The UE may be configured to automatically select a PLMN based on a comparison of a metric, such as a PLMN having a stronger measured RSSI value.

Searching PLMN resources may be a costly procedure, as a UE may use a large amount of power and a large amount of time to conduct tasks such as scanning each channel that it may support at 502 or decoding each PCPICH or SSB at 506. A UE may be configured to use PRS assistance data to reduce the costs of searching PLMN resources.

In one aspect, a UE may be configured to obtain an indication of a set of PLMNs. The UE may be configured to receive PRS assistance data from a network entity. The PRS assistance data may be associated with a set of PRSs for the set of PLMNs. The UE may be configured to select a subset of PLMNs in the set of PLMNs based on the PRS assistance data or at least one measurement for the set of PRSs. The UE may be configured to initiate a search for the subset of PLMNs based on the PRS assistance data or the at least one measurement for the set of PRSs.

In one aspect, a network entity may be configured to receive a request for a set of PLMNs from a UE. The network entity may be configured to transmit an indication of the set of PLMNs to the UE. The network entity may be configured to transmit PRS assistance data to the UE. The PRS assistance data may be associated with a set of PRSs for the set of PLMNs.

A UE, such as the UE 404 in FIG. 4, may obtain assistance data during a positioning session, such as from the positioning server via TRP 402 or TRP 406. The UE may receive assistance data from a plurality of PLMN within an HPLMN. The UE may obtain assistance data from a plurality of PLMN within both an HPLMN and a VPLMN. The UE may obtain assistance data from a public network and/or a private network. The UE may obtain assistance data from NR cells and/or LTE cells. Each DL-PRS that the UE receives, such as the DL-PRS 410 that the UE 404 receives, may have a set of PLMN associated with the DL-PRS. The PLMN may be obtained by the UE as an indication of a set of PLMNs, such as a set of PLMN IDs. In some aspects, the assistance data may include a cell global identifier or a cell identity.

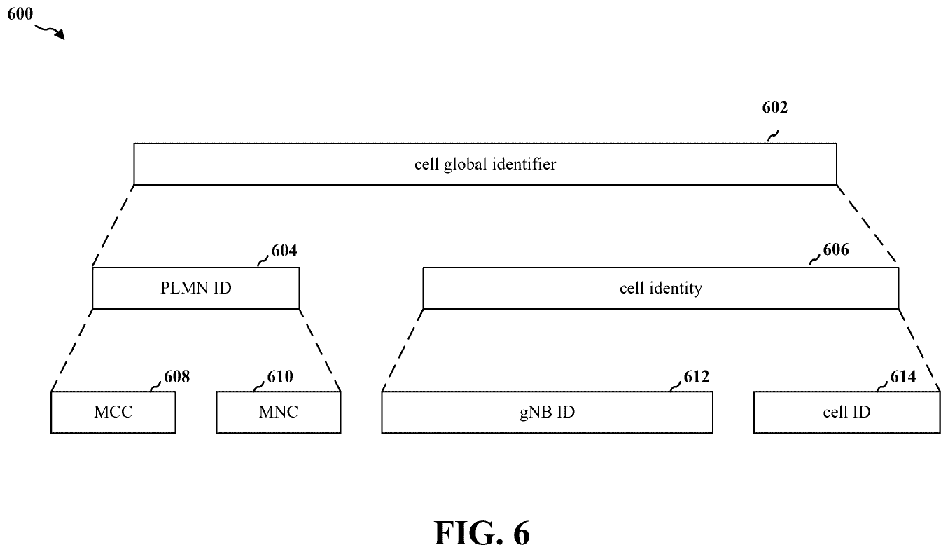

FIG. 6 shows a diagram 600 of a cell global identifier 602. The cell global identifier 602 may be, for example, an NR cell global identifier (NCGI) or an evolved universal terrestrial radio access (E-UTRA) cell global identifier (ECGI). The cell global identifier 602 may include a PLMN ID 604 and a cell identity 606. The PLMN ID 604 may include a mobile country code (MCC) 608 and a mobile network code (MNC) 610. The MCC 608 may be 3 bits long while the MNC 610 may be 2 or 3 bits long. The cell identity 606 may be, for example, an NR cell identity (NCI) or an LTE cell identity. The cell identity 606 may include a gNB ID 612 and a cell ID 614. The cell ID 614 may include, for example, a PCI. A UE may use the PLMN ID 604 to uniquely identify a PLMN within a geographic region, such as a country. A UE may use the cell identity 606 to identify one or more TRPs that the UE may use to connect to a network. When a UE executes a positioning session, a network entity may respond by transmitting a cell global identifier 602 in response. For example, when the UE 404 transmits a UL-SRS 412 to the TRP 406 and the TRP 402, the TRP 406 may transmit a DL-PRS 410 including a first cell global identifier in response, such as a cell global identifier 602 having PLMN and cell identity information specific to the TRP 406, and the TRP 402 may transmit a DL-PRS 410 including a second cell global identifier in response, such as a cell global identifier 602 having PLMN and cell identity information specific to the TRP 402. In other words, in response to a UL-SRS 412 transmission, the UE may receive a set of PLMN associated with one or more PRS. In some aspects, the network entity may respond by transmitting a cell identity 606 or a cell ID 614 in response to a request for PRS information.

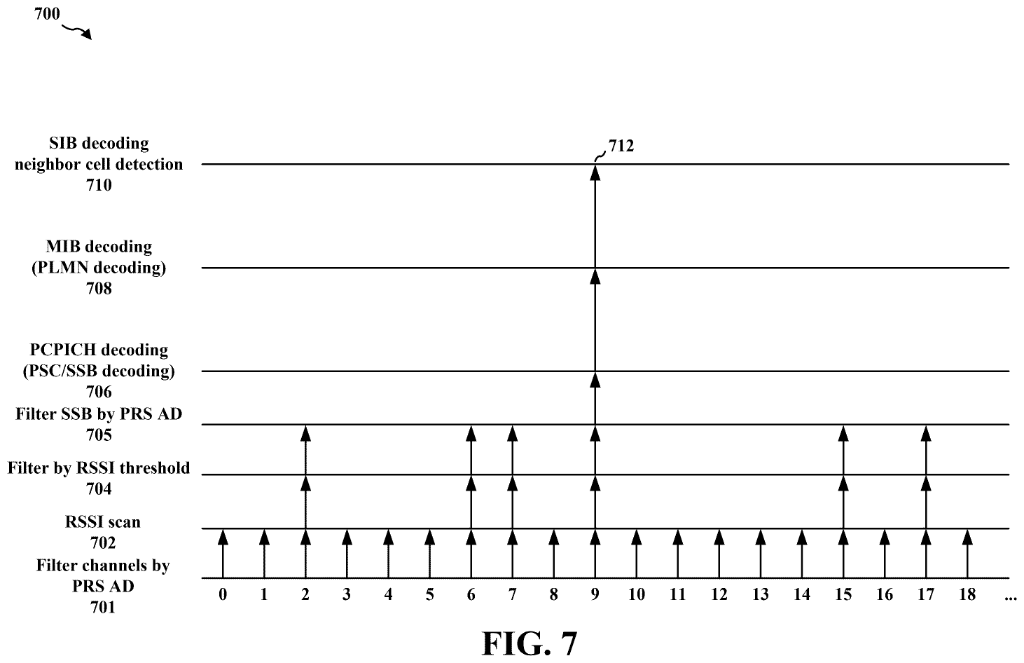

When a UE, such as the UE 404 in FIG. 4, receives assistance data from a network entity, the network entity may use the assistance data to reduce the costs of searching for PLMN resources. FIG. 7 shows a diagram 700 of a layered system that a UE, such as the UE 104 in FIG. 1, may use to search PLMN resources for cell selection by leveraging PRS assistance data. The assistance data may include, for example, a set of cell global identifiers from TRPs in a network, such as the cell global identifier 602 including a PLMN ID 604 and a cell identity 606. During a positioning session, the UE may receive assistance data associated with a set of PRSs for a set of PLMNs. The assistance data may include a set of PRS cell that are detected in one or more networks accessible by the UE. For example, using the assistance data, the UE may generate a list of PRS cell detected in NR and LTE networks accessible to the UE. At 701, the UE may filter the channels to search based on the PRS assistance data received from one or more network entities. In one aspect, the UE may have a set of channels that it supports. The UE may review the set of PRS assistance data for each PRS response, and map each PRS with a PLMN. Each PLMN may be associated with a set of frequencies or bands. The UE may then consider channels that are associated with the set of PLMN, and may not consider channels that are not associated with the set of PLMN. This reduces the number of channels that the UE may scan, as the UE may no longer scan all channels that it supports. Instead, the UE may scan a subset of channels that it supports having resources that are associated with the set of PLMNs associated with the set of PRS assistance data. In other words, the UE may generate a list of PLMN on which a PRS cell is detected, and filter channels to search based on the list of PLMN. In diagram 700, the UE may continue to consider channels 2, 6, 7, 9, 15, and 17 as channels having resources that are associated with the set of PLMNs associated with the set of PRS assistance data, and may filter out channels 0, 1, 3, 4, 5, 8, 10, 11, 12, 13, 14, 16, and 18 as channels that have resources that are not associated with the set of PLMNs associated with the set of PRS assistance data.

In some aspects, the UE may then proceed to decode PCPICH at 706, or may proceed to filter SSB by the PRS assistance data at 705. In some aspects, the UE may proceed to scan the subset of channels that are associated with the PRS assistance data at 702 to measure for RSSI of each of the subset of channels, similar to 502 in FIG. 5. At 704, the UE may filter the channels by the measured RSSI by comparing the measured RSSI against an RSSI threshold value, similar to 504 in FIG. 5.

At 705, the UE may decode the SSB channel and may filter SSB having operators that are associated with the set of PLMNs associated with the set of PRS assistance data. In other words, the UE may analyze the PRS assistance data to determine what operators are in the assistance data, may search SSBs for those operators, and may not search SSBs that do not have those operators. In diagram 700, the UE may continue to consider channel 9 as having an SSB with an operator that is associated with the PRS assistance data, and may not continue to consider channels 2, 6, 7, 15, and 17 as having SSBs with operators that are not associated with the PRS assistance data. At 706, the UE may scan the remaining channels to decode PCPICH at 706, similar to 506 in FIG. 5. At 708, the UE may decode the MIB of each remaining channel candidate, similar to 508 in FIG. 5. At 710, the UE may decode the SIB of the PLMN 712 to determine information for registering with the PLMN associated with the channel 9.

By utilizing PRS assistance data to filter channels and SSB, the UE may reduce the amount of costs for searching PLMN. The PRS assistance data may be associated with PLMN having resources that enable the UE to reduce the channels that the UE scans. The PRS data may be associated with operators that enable the UE to reduce the SSB that are decoded. In some aspects, the PRS assistance data may be used to both reduce the channels that the UE scans and reduce the SSB that are decoded. For example, a UE may initiate a manual PLMN search when the UE is in RRC inactive, or RRC idle mode during a positioning session, or after a positioning session. During the positioning session, the UE may receive a set of PRS cells from one or more network entities, such as LMFs or base stations. The UE may generate a set of PLMN on which the set of PRS cells is detected, and may decode the SSB channels and measure SSB RSSI on the detected PLMN from the set of PRS cells. The UE may generate a subset of PLMN for which RSSI is greater than a threshold value. The threshold value may be based on the UE implementation. The UE may then output the subset of PLMN cell associated with the set of PRS cells to an output user interface of the UE, such as a display or a speaker of the UE. The user may select a PLMN from the subset of PLMN via an input user interface of the UE, such as a touchscreen or a microphone. This may save PLMN processing time and/or power. The turnaround time for outputting the PLMN may also be reduced, as the UE may perform RSSI measurements on relevant PLMN rapidly. The user may alternatively choose not to select a PLMN from the subset of PLMN, for example by selecting to reject the subset of PLMN. In response to the user choosing not to select the PLMN from the subset of PLMN, the UE may perform a full PLMN search, for example by using the layered system shown in diagram 500 in FIG. 5.

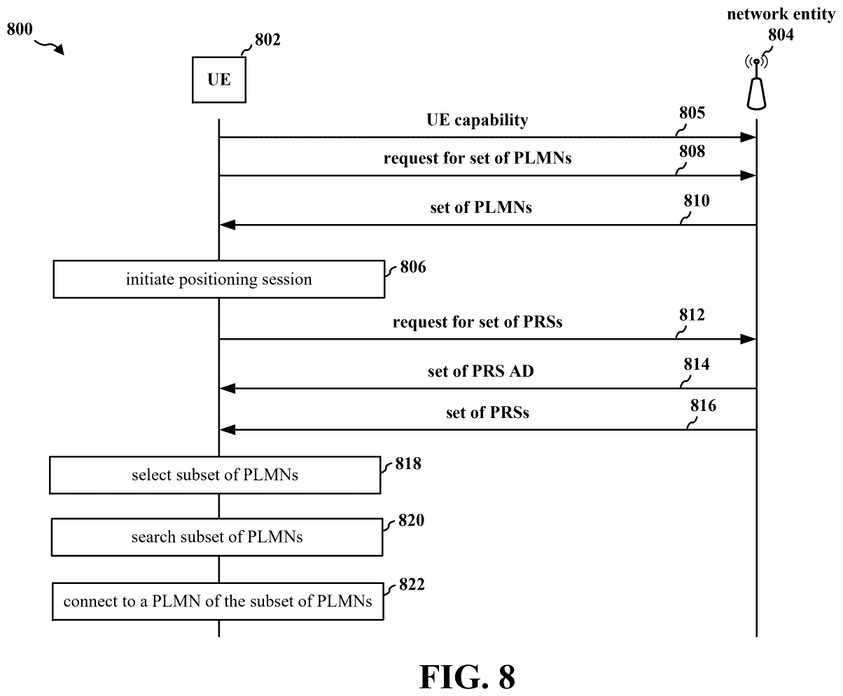

FIG. 8 shows a connection flow diagram 800 illustrating communication between a network entity 804 and a UE 802 configured to search PLMN resources for cell selection. In one aspect, the network entity 804 may include an LMF. The UE 802 may be configured to transmit a UE capability 805 to the network entity 804. The UE capability may include an indication that the UE 802 is capable of performing a PLMN search using PRS data, such as the set of PRS assistance data 814 or by measuring the set of PRSs 816. In response to receiving the UE capability 805, the network entity 804 may adjust the PRS assistance data for the UE 802 to have parameters that the UE 802 may use to perform a PLMN search. For example, the network entity 804 may provide a full cell global identifier to a UE 802 having a UE capability 805 that indicates that it is capable of performing a PLMN search using PRS data, and may instead provide a cell ID to a UE that does not have such a UE capability.

In one aspect, the UE may transmit a request 808 for a set of PLMNs to the network entity 804. The request 808 may be broadcast, multicast, or unicast to the network entity 804. The network entity 804 may obtain the request 808 for the set of PLMNs. The request 808 for the set of PLMNs may be an UL-SRS, such as the UL-SRS 412 in FIG. 4. In response to receiving the request 808 for the set of PLMNs, the network entity 804 may transmit the set of PLMNs 810 to the UE 802. The UE 802 may receive the set of PLMNs 810 from the network entity 804.

At 806, the UE 802 may perform a positioning session with the network entity 804, for example by transmitting an UL-SRS to the network entity 804, such as the UL-SRS 412 in FIG. 4.

In one aspect, the UE 802 may transmit a request 812 for a set of PRSs 816. The request 812 may be broadcast, multicast, or unicast to the network entity 804. The network entity 804 may obtain the request 812 for the set of PRSs. The request 812 for the set of PLMNs may be an UL-SRS, such as the UL-SRS 412 in FIG. 4. In response to receiving the request 812 for the set of PRSs, the network entity 804 may transmit the set of PRS assistance data 814 to the UE 802 and the set of PRSs 816 to the UE 802. The UE 802 may receive the set of PRS assistance data 814 and the set of PRSs 816 from the network entity 804. The set of PRS assistance data 814 may include, for example, cell global identifiers, such as the cell global identifier 602 in FIG. 6.

In one aspect, the set of PRS assistance data 814 may include a subset of the set of PLMNs 810. For example, where the set of PRS assistance data 814 includes a set of cell global identifiers, each cell global identifier may identify a PLMN. The UE 802 may use an identifier of each of the set of PLMN in order to determine information about the PLMN, such as one or more frequency identifiers or one or more operator identifiers.

At 818, the UE 802 may select a subset of PLMNs based on the set of PRS assistance data 814. In one aspect, the UE 802 may use the PRS assistance data 814 to filter channels to measure RSSI that are associated with the set of PLMNs. In another aspect, the UE 802 may use the PRS assistance data 814 to search SSBs associated with operators that are associated with the set of PLMNs. In another aspect, the UE 802 may use the PRS assistance data 814 both to filter channels to measure RSSI that are associated with the set of PLMNs and to filter SSBs associated with operators that are associated with the set of PLMNs.

In another aspect, the UE 802 may not receive the set of PRS assistance data 814. Instead, the UE 802 may measure the set of PRSs 816 to determine which PLMN of the set of PLMNs 810 are available in the vicinity of the UE 802. In some aspects, the UE 802 may transmit the measurements of the set of PRSs 816 to an LMF via the network entity 804, which may then store the measurements in a database of the LMF.

At 820, the UE 802 may search the subset of PLMNs, for example by using the layered system shown in the diagram 700 in FIG. 7. At 822, the UE 802 may register with a PLMN of the subset of PLMNs. For example, if the UE 802 is configured to perform manual PLMN selection, in response to receiving a selection of a PLMN from an input of the UE 802, the UE 802 may register with the selected PLMN. In another aspect, if the UE 802 is configured to perform automatic PLMN selection, the UE 802 may be configured to select a PLMN having the strongest measured RSSI value, and may register with the selected PLMN having the strongest measured RSSI value.

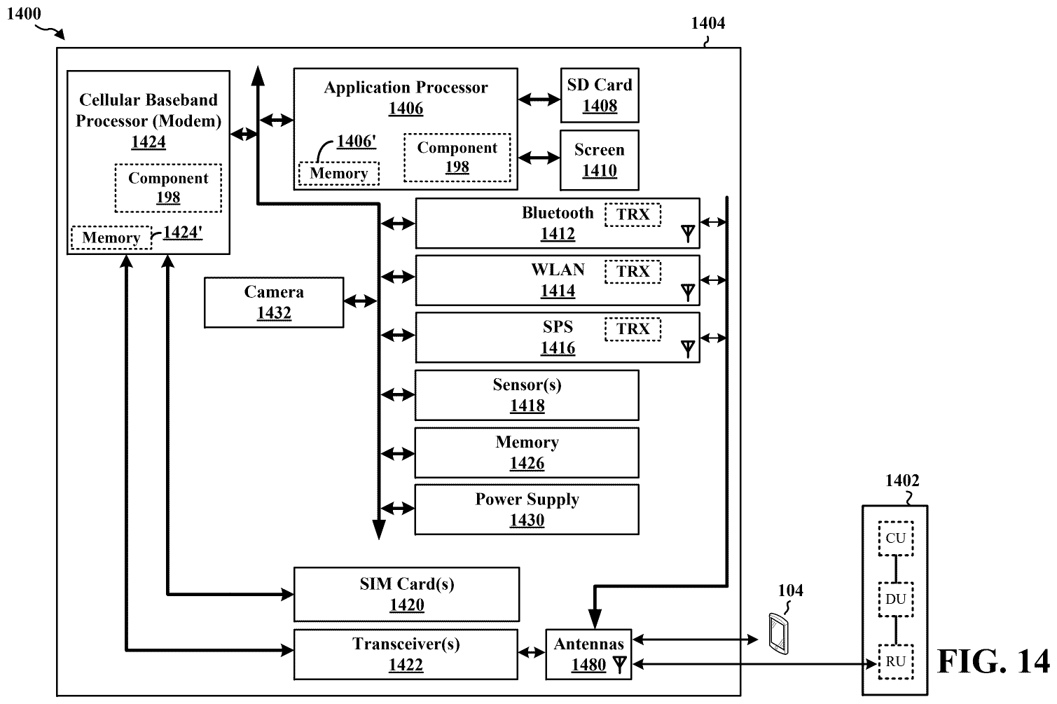

In one aspect, after each positioning session at 806, the UE 802 may be configured to update a subset of PLMN along with a timestamp. The UE 802 may maintain the subset of PLMN with the time stamp for every positioning session performed. The UE 802 may be configured to periodically perform the positioning session at 806 to maintain the subset of PLMN in the memory of the UE 802, such as the memory 360 in FIG. 3 or the memory 1406′ or 1424′ in FIG. 14. In response to a PLMN request from the UE 802 (e.g., a user of the UE may initiate a manual PLMN search), the UE 802 may determine if the latest subset of PLMN in the memory of the UE 802 is within a threshold time period of the current time. In response to the latest subset of PLMN in the memory of the UE 802 being within the threshold time period of the current time, the UE 802 may output the subset of PLMN to an output user interface of the UE 802, such as the screen 1410 in FIG. 14. In this manner, the UE 802 may provide a subset of PLMN to a user interface of the UE 802 rapidly without incurring much costs.

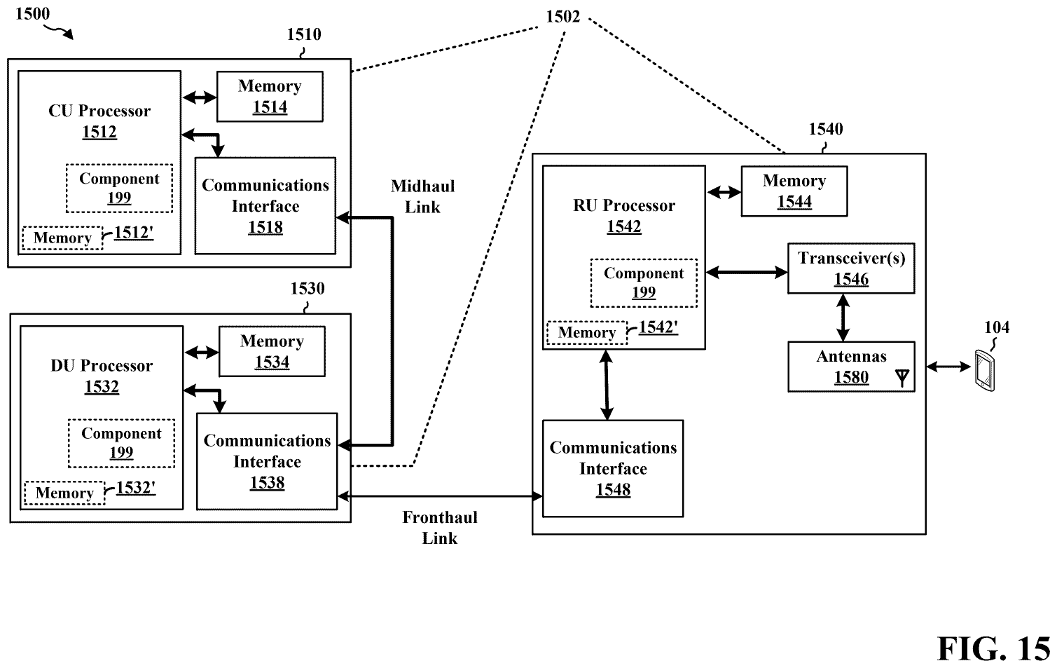

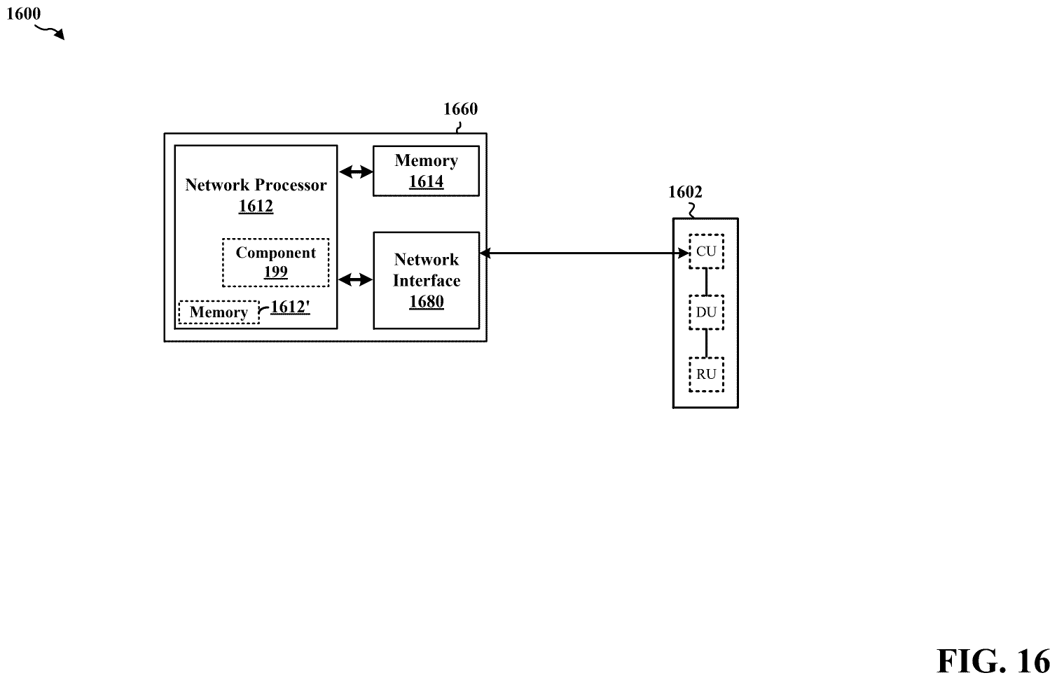

In another aspect, an LMF may maintain a list of potential PLMN for each UE location and serving cell. The LMF may save the list of potential PLMN for each UE location and serving cell in a database of the LMF, for example stored in the memory 1514, memory 1534, or the memory 1544 in FIG. 15, or stored in the memory 1614 in FIG. 16. The LMF may be accessible by the network entity 804. Instead of performing a full search of the set of PLMNs 810, the UE 802 may transmit a request to the LMF via the network entity 804 for potential PLMN. The LMF may transmit the list of potential PLMN associated with the location of the UE 802 via the network entity 804 to the UE 802. The UE 802 may then search the subset of PLMNs at 820 with a reduced cost.

In another aspect, the UE 802 may be in an RRC idle mode. The UE 802 may be aware of positioning assistance data through a positioning SIB (posSIB) received from the network entity 804. The posSIB may be broadcast periodically by the network entity 804. The posSIB may include assistance data from a set of area IDs. The UE 802 may use the positioning assistance data to prioritize a PLMN search on a subset of PLMN associated with the assistance data associated with the posSIB. In one aspect, at 820, the UE 802 may first search for the PLMN provided in the assistance data associated with the posSIB, and perform a scan on frequencies available in the band associated with the posSIB at a reduced cost.

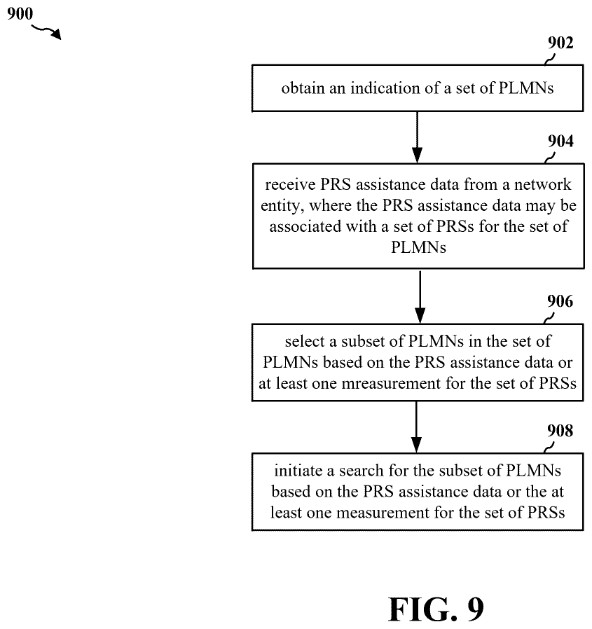

FIG. 9 is a flowchart 900 of a method of wireless communication. The method may be performed by a UE (e.g., the UE 104, the UE 350, the UE 404, the UE 802; the apparatus 1404). At 902, the UE may obtain an indication of a set of PLMNs. For example, 902 may be performed by the UE 802 in FIG. 8, which may obtain an indication of a set of PLMNs 810 from the network entity 804. Moreover, 902 may be performed by the component 198 in FIG. 14.

At 904, the UE may receive PRS assistance data from a network entity. The PRS assistance data may be associated with a set of PRSs for the set of PLMNs. For example, 904 may be performed by the UE 802 in FIG. 8, which may receive a set of PRS assistance data 814 from the network entity 804. The PRS assistance data may be associated with the set of PRSs 816 for the set of PLMNs 810. In some embodiments, the set of PRSs 816 may be associated with a subset of the set of PLMNs 810. Moreover, 904 may be performed by the component 198 in FIG. 14.

At 906, the UE may select a subset of PLMNs in the set of PLMNs based on the PRS assistance data or at least one measurement for the set of PRSs. For example, 906 may be performed by the UE 802 in FIG. 8, which may select a subset of PLMNs at 818 in the set of PLMNs 810 based on the PRS assistance data 814 or at least one measurement for the set of PRSs 816. Moreover, 906 may be performed by the component 198 in FIG. 14.

At 908, the UE initiate a search for the subset of PLMNs based on the PRS assistance data or the at least one measurement for the set of PRSs. For example, 908 may be performed by the UE 802 in FIG. 8, which may initiate a search for the subset of PLMNs at 820 based on the PRS assistance data 814 or the at least one measurement for the set of PRSs 816. Moreover, 908 may be performed by the component 198 in FIG. 14.

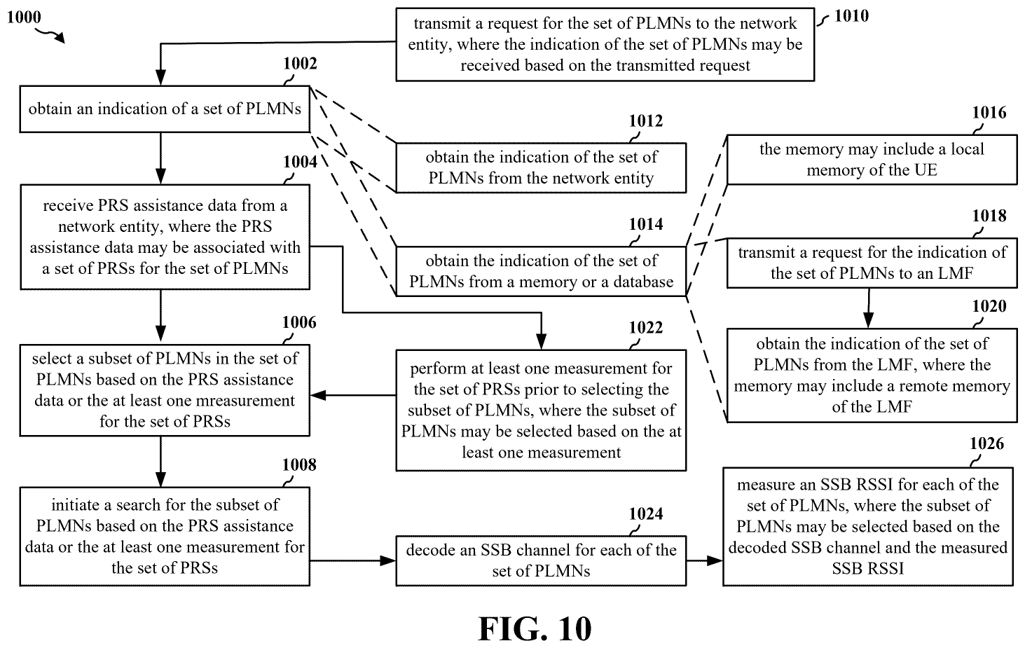

FIG. 10 is a flowchart 1000 of a method of wireless communication. The method may be performed by a UE (e.g., the UE 104, the UE 350, the UE 404, the UE 802; the apparatus 1404). At 1010, the UE may transmit a request for the set of PLMNs to the network entity. The indication of the set of PLMNs may be received based on the transmitted request. For example, 1010 may be performed by the UE 802 in FIG. 8, which may transmit a request 808 for the set of PLMNs 810 to the network entity 804. The indication of the set of PLMNs 810 may be received by the UE 802 based on the request 808 for the set of PLMNs 810. Moreover, 1010 may be performed by the component 198 in FIG. 14.

At 1002, the UE may obtain an indication of a set of PLMNs. For example, 1002 may be performed by the UE 802 in FIG. 8, which may obtain an indication of a set of PLMNs 810 from the network entity 804. Moreover, 1002 may be performed by the component 198 in FIG. 14.

At 1004, the UE may receive PRS assistance data from a network entity. The PRS assistance data may be associated with a set of PRSs for the set of PLMNs. For example, 1004 may be performed by the UE 802 in FIG. 8, which may receive a set of PRS assistance data 814 from the network entity 804. The PRS assistance data may be associated with the set of PRSs 816 for the set of PLMNs 810. In some embodiments, the set of PRSs 816 may be associated with a subset of the set of PLMNs 810. Moreover, 1004 may be performed by the component 198 in FIG. 14.

At 1006, the UE may select a subset of PLMNs in the set of PLMNs based on the PRS assistance data or at least one measurement for the set of PRSs. For example, 1006 may be performed by the UE 802 in FIG. 8, which may select a subset of PLMNs at 818 in the set of PLMNs 810 based on the PRS assistance data 814 or at least one measurement for the set of PRSs 816. Moreover, 1006 may be performed by the component 198 in FIG. 14.

At 1008, the UE initiate a search for the subset of PLMNs based on the PRS assistance data or the at least one measurement for the set of PRSs. For example, 1008 may be performed by the UE 802 in FIG. 8, which may initiate a search for the subset of PLMNs at 820 based on the PRS assistance data 814 or the at least one measurement for the set of PRSs 816. Moreover, 1008 may be performed by the component 198 in FIG. 14.

At 1012, the UE may obtain the indication of the set of PLMNs from the network entity. For example, 1012 may be performed by the UE 802 in FIG. 8, which may obtain the indication of the set of PLMNs 810 from the network entity 804. Moreover, 1012 may be performed by the component 198 in FIG. 14.

At 1014, the UE may obtain the indication of the set of PLMNs from a memory or a database. For example, 1014 may be performed by the UE 802 in FIG. 8, which may obtain the indication of the set of PLMNs 810 from a memory or a database, such as a memory of the UE 802 or the database of an LMF accessible via the network entity 804. Moreover, 1014 may be performed by the component 198 in FIG. 14.

At 1016, the UE 802 may have a local memory with the indication of the set of PLMNs 810. For example, 1016 may be performed by the UE 802 in FIG. 8, which may have a local memory, such as the memory 360 in FIG. 3 or the memory 1406′ or 1424′ in FIG. 14. Moreover, 1016 may be performed by the component 198 in FIG. 14.

At 1018, the UE may transmit a request for the indication of the set of PLMNs to an LMF. For example, 1018 may be performed by the UE 802 in FIG. 8, which may transmit a request 808 for the set of PLMNs 810 to the network entity 804, which may include an LMF, or may provide access to an LMF. Moreover, 1018 may be performed by the component 198 in FIG. 14.

At 1020, the UE may obtain the indication of the set of PLMNs from the LMF. The memory may include a remote memory of the LMF. For example, 1020 may be performed by the UE 802 in FIG. 8, which may obtain the indication of the set of PLMNs 810 from the network entity 804. The memory may include a remote memory of the network entity 804, such as the memory 1514, memory 1534, or the memory 1544 in FIG. 15, or stored in the memory 1614 in FIG. 16. Moreover, 1020 may be performed by the component 198 in FIG. 14.

At 1022, the UE may perform the at least one measurement for the set of PRSs prior to selecting the subset of PLMNs. The subset of PLMNs may be selected based on the at least one measurement. For example, 1022 may be performed by the UE 802 in FIG. 8, which may perform the at least one measurement for the set of PRSs 816 at 818 prior to selecting the subset of PLMNs. Moreover, 1022 may be performed by the component 198 in FIG. 14.

At 1024, the UE may decode an SSB channel for each of the set of PLMNs. For example, 1024 may be performed by the UE 802 in FIG. 8, which may decode an SSB channel for each of the set of PLMNs 810 at 818, for example by applying the layered system shown in diagram 700 in FIG. 7 to decode SSB at 706. Moreover, 1024 may be performed by the component 198 in FIG. 14.

At 1026, the UE may measure an SSB RSSI for each of the set of PLMNs. The subset of PLMNs may be selected based on the decoded SSB channel and the measured SSB RSSI. For example, 1026 may be performed by the UE 802 in FIG. 8, which may measure an SSB RSSI for each of the set of PLMNs 810 at 818. The subset of PLMNs selected at 818 may be selected based on the decoded SSB channel and the measured SSB RSSI. For example, the decoded SSB channel may have an operator associated with one of the set of the set of PRS assistance data 814, and may have a measured SSB RSSI greater than an RSSI threshold value. Moreover, 1026 may be performed by the component 198 in FIG. 14.

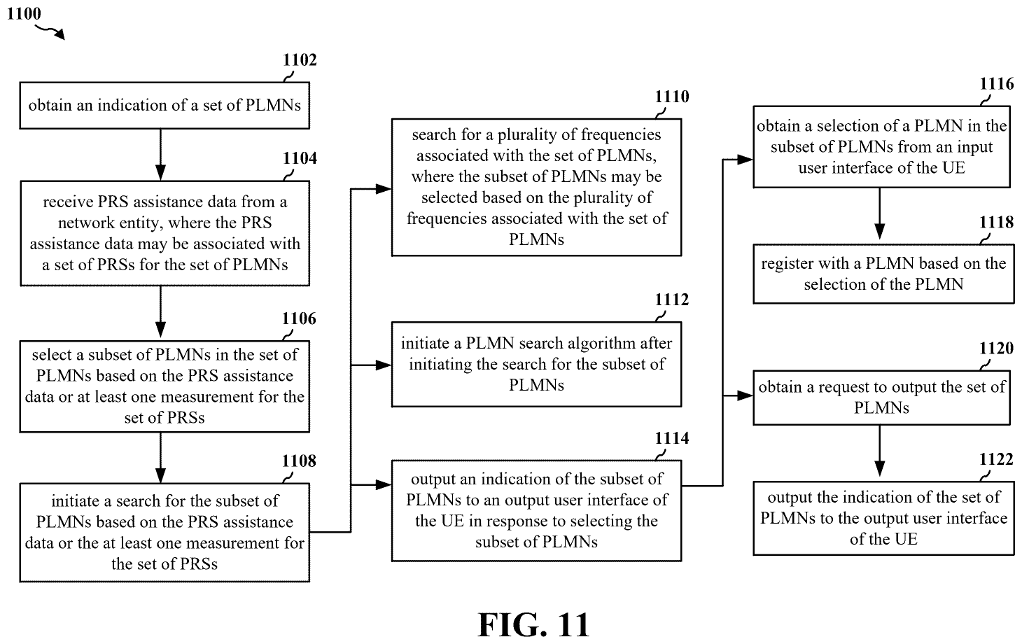

FIG. 11 is a flowchart 1100 of a method of wireless communication. The method may be performed by a UE (e.g., the UE 104, the UE 350, the UE 404, the UE 802; the apparatus 1404). At 1102, the UE may obtain an indication of a set of PLMNs. For example, 1102 may be performed by the UE 802 in FIG. 8, which may obtain an indication of a set of PLMNs 810 from the network entity 804. Moreover, 1102 may be performed by the component 198 in FIG. 14.

At 1104, the UE may receive PRS assistance data from a network entity. The PRS assistance data may be associated with a set of PRSs for the set of PLMNs. For example, 1104 may be performed by the UE 802 in FIG. 8, which may receive a set of PRS assistance data 814 from the network entity 804. The PRS assistance data may be associated with the set of PRSs 816 for the set of PLMNs 810. In some embodiments, the set of PRSs 816 may be associated with a subset of the set of PLMNs 810. Moreover, 1104 may be performed by the component 198 in FIG. 14.

At 1106, the UE may select a subset of PLMNs in the set of PLMNs based on the PRS assistance data or at least one measurement for the set of PRSs. For example, 1106 may be performed by the UE 802 in FIG. 8, which may select a subset of PLMNs at 818 in the set of PLMNs 810 based on the PRS assistance data 814 or at least one measurement for the set of PRSs 816. Moreover, 1106 may be performed by the component 198 in FIG. 14.

At 1108, the UE initiate a search for the subset of PLMNs based on the PRS assistance data or the at least one measurement for the set of PRSs. For example, 1108 may be performed by the UE 802 in FIG. 8, which may initiate a search for the subset of PLMNs at 820 based on the PRS assistance data 814 or the at least one measurement for the set of PRSs 816. Moreover, 1108 may be performed by the component 198 in FIG. 14.

At 1110, the UE may search for a plurality of frequencies associated with the set of PLMNs. The subset of PLMNs may be selected based on the plurality of frequencies associated with the set of PLMNs. For example, 1110 may be performed by the UE 802 in FIG. 8, which may search for a plurality of frequencies associated with the set of PLMNs 810 at 818. The subset of PLMNs selected at 818 may be selected based on the plurality of frequencies associated with the set of PLMNs 810. Moreover, 1110 may be performed by the component 198 in FIG. 14.

At 1112, the UE may initiate a PLMN search algorithm after initiating the search for the subset of PLMNs. For example, 1112 may be performed by the UE 802 in FIG. 8, which may initiate a PLMN search algorithm at 820 after initiating the search for the subset of PLMNs. Moreover, 1112 may be performed by the component 198 in FIG. 14.

At 1114, the UE may output an indication of the subset of PLMNs to an output user interface of the UE in response to selecting the subset of PLMNs. For example, 1114 may be performed by the UE 802 in FIG. 8, which may output an indication of the subset of PLMNs to an output user interface of the UE 802, such as the screen 1410 in FIG. 14, in response to selecting the subset of PLMNs at 818. Moreover, 1114 may be performed by the component 198 in FIG. 14.

At 1116, the UE may obtain a selection of a PLMN in the subset of PLMNs from an input user interface of the UE. For example, 1116 may be performed by the UE 802 in FIG. 8, which may obtain a selection of a PLMN in the subset of PLMNs from an input user interface of the UE 802, such as a touchscreen shown as the screen 1410 in FIG. 14. Moreover, 1116 may be performed by the component 198 in FIG. 14.

At 1118, the UE may register with a PLMN based on the selection of the PLMN. For example, 1118 may be performed by the UE 802 in FIG. 8, which may register with a PLMN based on a selection of PLMN at 822. Moreover, 1118 may be performed by the component 198 in FIG. 14.

At 1120, the UE may obtain a request to output the set of PLMNs. For example, 1120 may be performed by the UE 802 in FIG. 8, which may obtain a request to output the set of PLMNs from an input user interface of the UE 802. Moreover, 1120 may be performed by the component 198 in FIG. 14.

At 1122, the UE may output the indication of the set of PLMNs to the output user interface of the UE. For example, 1122 may be performed by the UE 802 in FIG. 8, which may output the indication of the set of PLMNs 810 to the output user interface of the UE 802, such as the screen 1410 in FIG. 14. Moreover, 1122 may be performed by the component 198 in FIG. 14.

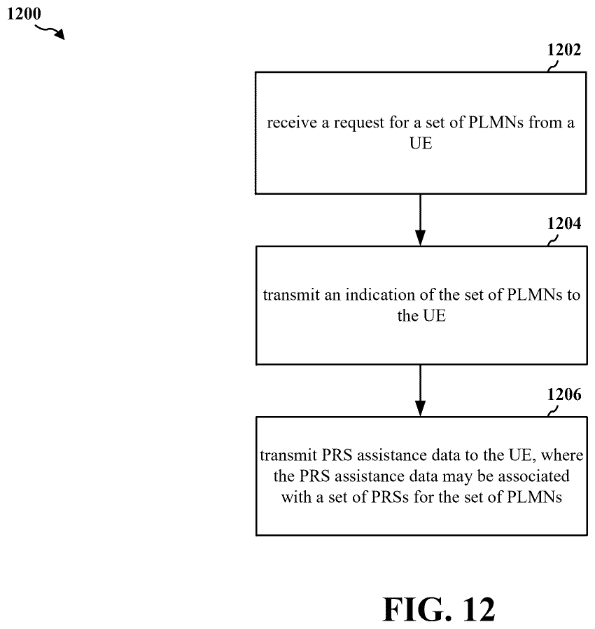

FIG. 12 is a flowchart 1200 of a method of wireless communication. The method may be performed by a network entity (e.g., the base station 102, the base station 310; the network entity 804, the network entity 1402, the network entity 1502, the network entity 1660; the TRP 402, the TRP 406). At 1202, the network entity may receive a request for a set of PLMNs from a UE. For example, 1202 may be performed by the network entity 804 in FIG. 8, which may receive a request 808 for a set of PLMNs from the UE 802. Moreover, 1202 may be performed by the component 199 in FIGS. 15 and 16.

At 1204, the network entity may transmit an indication of the set of PLMNs to the UE. For example, 1204 may be performed by the network entity 804 in FIG. 8, which may transmit an indication of the set of PLMNs 810 to the UE 802. Moreover, 1204 may be performed by the component 199 in FIGS. 15 and 16.

At 1206, the network entity may transmit PRS assistance data to the UE. The PRS assistance data may be associated with a set of PRSs for the set of PLMNs. For example, 1206 may be performed by the network entity 804 in FIG. 8, which may transmit a set of PRS assistance data 814 to the UE 802. The PRS assistance data 814 may be associated with the set of PRSs 816. Moreover, 1206 may be performed by the component 199 in FIGS. 15 and 16.

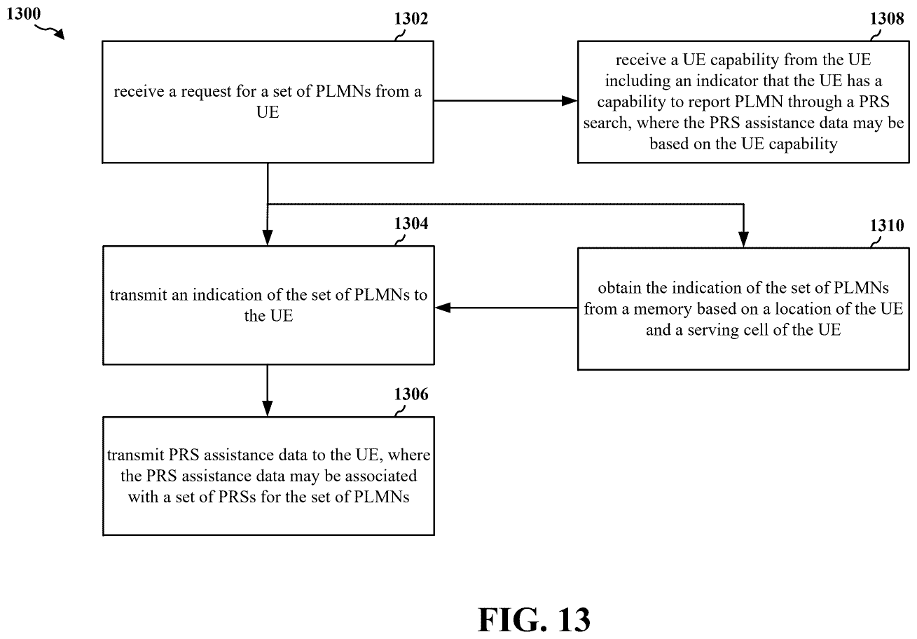

FIG. 13 is a flowchart 1300 of a method of wireless communication. The method may be performed by a network entity (e.g., the base station 102, the base station 310; the network entity 804, the network entity 1402, the network entity 1502, the network entity 1660; the TRP 402, the TRP 406). At 1302, the network entity may receive a request for a set of PLMNs from a UE. For example, 1302 may be performed by the network entity 804 in FIG. 8, which may receive a request 808 for a set of PLMNs from the UE 802. Moreover, 1302 may be performed by the component 199 in FIGS. 15 and 16.

At 1304, the network entity may transmit an indication of the set of PLMNs to the UE. For example, 1304 may be performed by the network entity 804 in FIG. 8, which may transmit an indication of the set of PLMNs 810 to the UE 802. Moreover, 1304 may be performed by the component 199 in FIGS. 15 and 16.

At 1306, the network entity may transmit PRS assistance data to the UE. The PRS assistance data may be associated with a set of PRSs for the set of PLMNs. For example, 1306 may be performed by the network entity 804 in FIG. 8, which may transmit a set of PRS assistance data 814 to the UE 802. The PRS assistance data 814 may be associated with the set of PRSs 816. Moreover, 1306 may be performed by the component 199 in FIGS. 15 and 16.

At 1308, the network entity may receive a UE capability from the UE including an indicator that the UE has a capability to report PLMN through a PRS search. The PRS assistance data may be based on the UE capability. For example, 1308 may be performed by the network entity 804 in FIG. 8, which may receive a UE capability from the UE 802 including an indicator that the UE 802 has a capability to report PLMN through a PRS search. Moreover, 1308 may be performed by the component 199 in FIGS. 15 and 16.

At 1310, the network entity may obtain the indication of the set of PLMNs from a memory based on a location of the UE and a serving cell of the UE. For example, 1310 may be performed by the network entity 804 in FIG. 8, which may obtain the indication of the set of PLMNs 810 from a memory based on a location of the UE 802 and a serving cell of the UE 802. Moreover, 1310 may be performed by the component 199 in FIGS. 15 and 16.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); magnetometer, audio and/or other technologies used for positioning), memory 1426, a power supply 1430, and/or a camera 1432. The Bluetooth module 1412, the WLAN module 1414, and the SPS module 1416 may include an on-chip transceiver (TRX) (or in some cases, just a receiver). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The memory 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the Tx processor 368, the Rx processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see UE 350 of FIG. 3) and include the additional modules of the apparatus 1404.

As discussed supra, the component 198 may be configured to obtain an indication of a set of PLMNs. The component 198 may be configured to receive PRS assistance data from a network entity. The PRS assistance data may be associated with a set of PRSs for the set of PLMNs. The component 198 may be configured to select a subset of PLMNs in the set of PLMNs based on the PRS assistance data or at least one measurement for the set of PRSs. The component 198 may be configured to initiate a search for the subset of PLMNs based on the PRS assistance data or the at least one measurement for the set of PRSs. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, may include means for obtaining an indication of a set of PLMNs. The apparatus 1404 may include means for receiving PRS assistance data from a network entity. The apparatus 1404 may include means for selecting a subset of PLMNs in the set of PLMNs based on the PRS assistance data or at least one measurement for the set of PRSs. The apparatus 1404 may include means for initiating a search for the subset of PLMNs based on the PRS assistance data or the at least one measurement for the set of PRSs. The apparatus 1404 may include means for transmitting a request for the set of PLMNs to the network entity. The apparatus 1404 may include means for obtaining the indication of the set of PLMNs by obtaining the indication of the set of PLMNs from the network entity. The apparatus 1404 may include means for obtaining the indication of the set of PLMNs by obtaining the indication of the set of PLMNs from a memory or a database. The apparatus 1404 may include means for obtaining the indication of the set of PLMNs from the memory or the database by transmitting a request for the indication of the set of PLMNs to an LMF. The apparatus 1404 may include means for obtaining the indication of the set of PLMNs from the memory by obtaining the indication of the set of PLMNs from the LMF. The database may include a remote database of the LMF. The apparatus 1404 may include means for performing the at least one measurement for the set of PRSs prior to selecting the subset of PLMNs. The apparatus 1404 may include means for searching for a plurality of frequencies associated with the set of PLMNs. The apparatus 1404 may include means for decoding an SSB channel for each of the set of PLMNs. The apparatus 1404 may include means for measuring an SSB RSSI for each of the set of PLMNs. The apparatus 1404 may include means for initiating a PLMN search algorithm after initiating the search for the subset of PLMNs. The apparatus 1404 may include means for outputting an indication of the subset of PLMNs to an output user interface of the UE in response to selecting the subset of PLMNs. The apparatus 1404 may include means for obtaining a selection of at least one PLMN in the subset of PLMNs from an input user interface of the UE. The apparatus 1404 may include means for registering with the PLMN based on the selection of the at least one PLMN. The apparatus 1404 may include means for obtaining a request to present the set of PLMNs. The apparatus 1404 may include means for outputting the indication of the set of PLMNs to the output user interface of the UE. The means may be the component 198 of the apparatus 1404 configured to perform the functions recited by the means. As described supra, the apparatus 1404 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include memory 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include memory 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include memory 1544, one or more transceivers 1546, antennas 1580, and a communications interface 1548. The RU 1540 communicates with the UE 104. The on-chip memory 1512′, 1532′, 1542′ and the memory 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive a request for a set of PLMNs from a UE. The component 199 may be configured to transmit an indication of the set of PLMNs to the UE. The component 199 may be configured to transmit PRS assistance data to the UE. The PRS assistance data may be associated with a set of PRSs for the set of PLMNs. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 may include means for receiving a request for a set of PLMNs from a UE. The network entity 1502 may include means for transmitting an indication of the set of PLMNs to the UE. The network entity 1502 may include means for transmitting PRS assistance data to the UE. The network entity 1502 may include means for receiving a UE capability from the UE including an indicator that the UE has a capability to report PLMN through a PRS search. The network entity 1502 may include means for obtaining the indication of the set of PLMNs from a memory based on a location of the UE and a serving cell of the UE. The means may be the component 199 of the network entity 1502 configured to perform the functions recited by the means. As described supra, the network entity 1502 may include the Tx processor 316, the Rx processor 370, and the controller/processor 375. As such, in one configuration, the means may be the Tx processor 316, the Rx processor 370, and/or the controller/processor 375 configured to perform the functions recited by the means.

FIG. 16 is a diagram 1600 illustrating an example of a hardware implementation for a network entity 1660. In one example, the network entity 1660 may be within the core network 120. The network entity 1660 may include a network processor 1612. The network processor 1612 may include on-chip memory 1612′. In some aspects, the network entity 1660 may further include memory 1614. The network entity 1660 communicates via the network interface 1680 directly (e.g., backhaul link) or indirectly (e.g., through a RIC) with the CU 1602. The on-chip memory 1612′ and the memory 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive a request for a set of PLMNs from a UE. The component 199 may be configured to transmit an indication of the set of PLMNs to the UE. The component 199 may be configured to transmit PRS assistance data to the UE. The component 199 may be within the processor 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 may include means for receiving a request for a set of PLMNs from a UE. The network entity 1660 may include means for transmitting an indication of the set of PLMNs to the UE. The network entity 1660 may include means for transmitting PRS assistance data to the UE. The network entity 1660 may include means for receiving a UE capability from the UE including an indicator that the UE has a capability to report PLMN through a PRS search. The network entity 1660 may include means for obtaining the indication of the set of PLMNs from a memory based on a location of the UE and a serving cell of the UE. The means may be the component 199 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include obtaining an indication of a set of PLMNs. The method may further include receiving PRS assistance data from a network entity. The PRS assistance data may be associated with a set of PRSs for the set of PLMNs. The method may include selecting a subset of PLMNs in the set of PLMNs based on the PRS assistance data or at least one measurement for the set of PRSs. The method may include initiating a search for the subset of PLMNs based on the PRS assistance data or the at least one measurement for the set of PRSs.

Aspect 2 is the method of aspect 1, where the method may include transmitting a request for the set of PLMNs to the network entity. The indication of the set of PLMNs may be received based on the transmitted request.

Aspect 3 is the method of any of aspects 1 and 2, where obtaining the indication of the set of PLMNs may include obtaining the indication of the set of PLMNs from the network entity.

Aspect 4 is the method of any of aspects 1 to 3, where obtaining the indication of the set of PLMNs may include obtaining the indication of the set of PLMNs from a memory or a database.

Aspect 5 is the method of aspect 4, where the memory may include a local memory of the UE.

Aspect 6 is the method of aspect 4, where obtaining the indication of the set of PLMNs from the memory or the database may include transmitting a request for the indication of the set of PLMNs to an LMF. Obtaining the indication of the set of PLMNs from the memory may include obtaining the indication of the set of PLMNs from the LMF. The database may include a remote database of the LMF.

Aspect 7 is the method of any of aspects 1 to 6, where the method may include performing the at least one measurement for the set of PRSs prior to selecting the subset of PLMNs. The subset of PLMNs may be selected based on the at least one measurement.

Aspect 8 is the method of any of aspects 1 to 7, where the method may include searching for a plurality of frequencies associated with the set of PLMNs. The subset of PLMNs may be selected based on the plurality of frequencies associated with the set of PLMNs.

Aspect 9 is the method of any of aspects 1 to 8, where the method may include decoding an SSB channel for each of the set of PLMNs. The method may include measuring an SSB RSSI for each of the set of PLMNs. The subset of PLMNs may be selected based on the decoded SSB channel and the measured SSB RSSI.

Aspect 10 is the method of any of aspects 1 to 9, where each of the subset of PLMNs may be selected based on a RSSI of the PLMN being greater than or equal to a threshold.

Aspect 11 is the method of any of aspects 1 to 10, where the search for the subset of PLMNs may be initiated during a positioning session of the UE or after the positioning session of the UE.

Aspect 12 is the method of any of aspects 1 to 11, where the search for the subset of PLMNs may be initiated during a RRC idle mode of the UE or an RRC inactive mode of the UE.

Aspect 13 is the method of any of aspects 1 to 12, where the method may include initiating a PLMN search algorithm after initiating the search for the subset of PLMNs.

Aspect 14 is the method of any of aspects 1 to 13, where the PLMN search algorithm may be initiated in response to the search for the subset of PLMNs being unsuitable for the UE.

Aspect 15 is the method of any of aspects 1 to 14, where the method may include outputting an indication of the subset of PLMNs to an output user interface of the UE in response to selecting the subset of PLMNs.

Aspect 16 is the method of aspect 15, where the method may include obtaining a selection of at least one PLMN in the subset of PLMNs from an input user interface of the UE. The method may include registering with a PLMN based on the selection of the at least one PLMN.

Aspect 17 is the method of aspect 15, where the method may include obtaining a request to present the set of PLMNs. The method may include outputting the indication of the set of PLMNs to the output user interface of the UE.

Aspect 18 is a method of wireless communication at a network entity, where the method may include receiving a request for a set of PLMNs from a UE. The method may include transmitting an indication of the set of PLMNs to the UE. The method may include transmitting PRS assistance data to the UE. The PRS assistance data may be associated with a set of PRSs for the set of PLMNs.

Aspect 19 is the method of aspect 18, where the method may include receiving a UE capability from the UE including an indicator that the UE has a capability to report PLMN through a PRS search. The PRS assistance data may be based on the UE capability.

Aspect 20 is the method of any of aspects 18 and 19, where the method may include obtaining the indication of the set of PLMNs from a memory based on a location of the UE and a serving cell of the UE.

Aspect 21 is the method of any of aspects 18 to 20, where the network entity may include an LMF.

Aspect 22 is an apparatus for wireless communication, including: a memory; and at least one processor coupled to the memory and, based at least in part on information stored in the memory, the at least one processor is configured to implement any of aspects 1 to 21.

Aspect 23 is the apparatus of aspect 22, further including at least one of an antenna or a transceiver coupled to the at least one processor.

Aspect 24 is an apparatus for wireless communication including means for implementing any of aspects 1 to 21.

Aspect 25 is a computer-readable medium (e.g., a non-transitory computer-readable medium) storing computer executable code, where the code when executed by a processor causes the processor to implement any of aspects 1 to 21.

What is claimed is:

1. An apparatus for wireless communication at a user equipment (UE), comprising:
a memory; and
at least one processor coupled to the memory and, based at least in part on information stored in the memory, the at least one processor is configured to:
obtain an indication of a set of public land mobile networks (PLMNs);
receive positioning reference signal (PRS) assistance data from a network entity, wherein the PRS assistance data is associated with a set of PRSs for the set of PLMNs;
select a subset of PLMNs in the set of PLMNs based on the PRS assistance data or at least one measurement for the set of PRSs; and
initiate a search for the subset of PLMNs based on the PRS assistance data or the at least one measurement for the set of PRSs.

2. The apparatus of claim 1, further comprising a transceiver coupled to the at least one processor, wherein the at least one processor is further configured to:
transmit, via the transceiver, a request for the set of PLMNs to the network entity, wherein the indication of the set of PLMNs is received based on the transmitted request.

3. The apparatus of claim 1, wherein, to obtain the indication of the set of PLMNs, the at least one processor is configured to:
obtain the indication of the set of PLMNs from the network entity.

4. The apparatus of claim 1, wherein, to obtain the indication of the set of PLMNs, the at least one processor is configured to:
obtain the indication of the set of PLMNs from a first memory or a database.

5. The apparatus of claim 4, wherein the memory comprises a local memory of the UE.

6. The apparatus of claim 4, wherein, to obtain the indication of the set of PLMNs from the memory or the database, the at least one processor is configured to:
transmit a request for the indication of the set of PLMNs to a location management function (LMF); and
obtain the indication of the set of PLMNs from the LMF, wherein the database comprises a remote database of the LMF.

7. The apparatus of claim 1, wherein the at least one processor is further configured to:
perform the at least one measurement for the set of PRSs prior to selecting the subset of PLMNs, wherein the subset of PLMNs is selected based on the at least one measurement.

8. The apparatus of claim 1, wherein the at least one processor is further configured to:
search for a plurality of frequencies associated with the set of PLMNs, wherein the subset of PLMNs is selected based on the plurality of frequencies associated with the set of PLMNs.

9. The apparatus of claim 1, wherein the at least one processor is further configured to:
decode a synchronization signal block (SSB) channel for each of the set of PLMNs; and
measure an SSB received signal strength indicator (RSSI) for each of the set of PLMNs, wherein the subset of PLMNs is selected based on the decoded SSB channel and the measured SSB RSSI.

10. The apparatus of claim 1, wherein each of the subset of PLMNs is selected based on a received signal strength indicator (RSSI) of the PLMN being greater than or equal to a threshold.

11. The apparatus of claim 1, wherein the search for the subset of PLMNs is initiated during a positioning session of the UE or after the positioning session of the UE.

12. The apparatus of claim 1, wherein the search for the subset of PLMNs is initiated during a radio resource control (RRC) idle mode of the UE or an RRC inactive mode of the UE.

13. The apparatus of claim 1, wherein the at least one processor is further configured to:
initiate a PLMN search algorithm after initiating the search for the subset of PLMNs.

14. The apparatus of claim 13, wherein the PLMN search algorithm is initiated in response to the search for the subset of PLMNs being unsuitable for the UE.

15. The apparatus of claim 1, wherein the at least one processor is further configured to:
output an indication of the subset of PLMNs to an output user interface of the UE in response to selecting the subset of PLMNs.

16. The apparatus of claim 15, wherein the at least one processor is further configured to:
obtain a selection of at least one PLMN in the subset of PLMNs from an input user interface of the UE; and
register with a PLMN based on the selection of the at least one PLMN.

17. The apparatus of claim 15, wherein the at least one processor is further configured to:
obtain a request to output the indication of the set of PLMNs; and
output the indication of the set of PLMNs to the output user interface of the UE.

18. An apparatus for wireless communication at a network entity, comprising:
a memory; and
at least one processor coupled to the memory and, based at least in part on information stored in the memory, the at least one processor is configured to:
receive a request for a set of public land mobile networks (PLMNs) from a user equipment (UE);
transmit an indication of the set of PLMNs to the UE; and
transmit positioning reference signal (PRS) assistance data to the UE,
wherein the PRS assistance data is associated with a set of PRSs for the set of PLMNs.

19. The apparatus of claim 18, further comprising a transceiver coupled to the at least one processor, wherein the at least one processor is further configured to:
receive, via the transceiver, a UE capability from the UE comprising an indicator that the UE has a capability to report PLMN through a PRS search, wherein the PRS assistance data is based on the UE capability.

20. The apparatus of claim 18, wherein the at least one processor is further configured to:
obtain the indication of the set of PLMNs from a first memory based on a location of the UE and a serving cell of the UE.

21. The apparatus of claim 18, wherein the network entity comprises a location management function (LMF).

22. A method of wireless communication at a user equipment (UE), comprising:
obtaining an indication of a set of public land mobile networks (PLMNs);
receiving positioning reference signal (PRS) assistance data from a network entity, wherein the PRS assistance data is associated with a set of PRSs for the set of PLMNs;
selecting a subset of PLMNs in the set of PLMNs based on the PRS assistance data or at least one measurement for the set of PRSs; and
initiating a search for the subset of PLMNs based on the PRS assistance data or the at least one measurement for the set of PRSs.

23. The method of claim 22, further comprising:
transmitting a request for the set of PLMNs to the network entity, wherein the indication of the set of PLMNs is received based on the transmitted request.

24. The method of claim 22, wherein obtaining the indication of a set of PLMNs comprises:
receiving the indication of the set of PLMNs from the network entity.

25. The method of claim 22, further comprising:
performing the at least one measurement for the set of PRSs prior to selecting the subset of PLMNs, wherein the subset of PLMNs is selected based on the at least one measurement.

26. The method of claim 22, further comprising:
searching for a plurality of frequencies associated with the set of PLMNs, wherein the subset of PLMNs is selected based on the plurality of frequencies associated with the set of PLMNs.

27. The method of claim 22, further comprising:
decoding a synchronization signal block (SSB) channel for each of the set of PLMNs; and
measuring an SSB received signal strength indicator (RSSI) for each of the set of PLMNs, wherein the subset of PLMNs is selected based on the decoded SSB channel and the measured SSB RSSI.

28. A method of wireless communication at a network entity, comprising:
receiving a request for a set of public land mobile networks (PLMNs) from a user equipment (UE);
transmitting an indication of the set of PLMNs to the UE; and
transmitting positioning reference signal (PRS) assistance data to the UE, wherein the PRS assistance data is associated with a set of PRSs for the set of PLMNs.

29. The method of claim 28, further comprising:
receiving a UE capability from the UE comprising an indicator that the UE has a capability to report PLMN through a PRS search, wherein the PRS assistance data is based on the UE capability.

30. The method of claim 28, further comprising:
obtaining the indication of the set of PLMNs from a memory based on a location of the UE and a serving cell of the UE.
